(19) United States
(12) Patent Application Publication
(10) Pub. No.: US 2023/0252246 A1
(43) Pub. Date: Aug. 10, 2023

(54) CABIN CREW ASSIST ON AN AIRCRAFT

(71) Applicant: The Boeing Company, Chicago, IL (US)

(72) Inventors: Vinay Kumar Tumkur Chandrashekar, Bengaluru (IN); Vinayak M. Nyamagoudar, Bengaluru (IN); Aswin Chandar N C, Bengaluru (IN); Richa Talwar, Bengaluru (IN)

(73) Assignee: The Boeing Company, Chicago, IL (US)

(21) Appl. No.: 17/665,725

(22) Filed: Feb. 7, 2022

(51) Int. Cl. G06F 40/58; G06F 3/0482; G10L 15/26; B64D 11/00

(52) U.S. Cl. CPC G06F 40/58; G06F 3/0482; G10L 15/26; B64D 11/0015; H04W 88/08

(57) ABSTRACT

A method for cabin crew assist on an aircraft includes receiving a passenger source language selection for a particular seat, receiving a passenger electrical signal representative of passenger spoken words, converting the passenger electrical signal to a passenger source text message, buffering the passenger source text message and activating a service indicator on an assist display. The service indicator identifies the particular seat. The method include receiving a crew target language selection from the assist display. Translating the passenger source text message to a crew target text message in the crew target language. Displaying the crew target text message associated with the particular seat on the assist display.

### TECHNICAL FIELD

The disclosure relates generally to interactions between cabin crew members and passengers, and in particular, to cabin crew assist on an aircraft.

### BACKGROUND

Passengers on a commercial aircraft typically request assistance from the cabin crew members by activating a call from an overhead call button or an in-flight entertainment system. The call button is often shared among a group of passengers in each row. Once a cabin crew member reaches the active call button, the call button is reset and the request is taken verbally by the cabin crew member. The cabin crew member subsequently walks to a galley area of the aircraft, obtains appropriate supplies, returns to the requesting seat, and fulfills the request. Walking back and forth between the galley area and the passenger seats increases congestion across the aisle, and increases fatigue to the cabin crew members. If the passenger speaks a different language than the cabin crew members, communication of the request becomes difficult. Furthermore, since the call buttons are shared among several passengers in each row and the cabin crew members, repeated touching of the call buttons provides transfer points for germs and viruses.

Accordingly, those skilled in the art continue with research and development efforts in the field of improving communications among cabin crew members and passengers while reducing commonly-used transfer points.

### SUMMARY

A method for cabin crew assist on an aircraft is provided herein. The method includes receiving a passenger source language selection for a particular seat of a plurality of seats of the aircraft at a server computer. The passenger source language selection designates a passenger source language among a plurality of recognizable languages. The method further includes receiving a passenger electrical signal representative of one or more passenger spoken words originating from the particular seat, converting the passenger electrical signal to a passenger source text message based on the passenger source language, buffering the passenger source text message, activating a service indicator on an assist display of the aircraft in response to the passenger source text message being buffered, wherein the service indicator identifies the particular seat, receiving a crew target language selection from the assist display. The crew target language selection designates a crew target language among the plurality of recognizable languages. The method includes translating the passenger source text message to a crew target text message in the crew target language based on the passenger source language and the crew target language, and displaying the crew target text message associated with the particular seat on the assist display.

In one or more embodiments, the method includes generating the passenger electrical signal with a passenger microphone in an in-flight entertainment system, wherein the in-flight entertainment system is mounted proximate the particular seat.

In one or more embodiments, the method includes generating the passenger electrical signal in a handheld device. The handheld device is paired to the particular seat. The method further includes transferring the passenger electrical signal from the handheld device to a wireless access point located in the aircraft, and transferring the passenger electrical signal from the wireless access point to the server computer.

In one or more embodiments, the method includes receiving an acknowledge selection from the assist display after the crew target text message is displayed on the assist display.

In one or more embodiments, the method includes removing the crew target text message from the assist display in response to the acknowledge selection.

In one or more embodiments, the method includes displaying the passenger source text message in the passenger source language on a passenger display for the particular seat.

In one or more embodiments, the method includes receiving a passenger target language selection for the particular seat. The passenger target language selection designates a passenger target language among the plurality of recognizable languages. The passenger target language is different than the passenger source language.

In one or more embodiments, the method includes translating the passenger source text message from the passenger source language to the passenger target language, and displaying the passenger source text message in the passenger target language at the particular seat.

In one or more embodiments, the method includes receiving a passenger target language selection for the particular seat among the plurality of seats of the aircraft. The passenger target language selection designates a passenger target language among the plurality of recognizable languages. The method further includes receiving a crew source language selection selected from the assist display of the aircraft at the server computer. The crew source language selection designates a crew source language among the plurality of recognizable languages. The method includes receiving a notification that a public announcement is active in the aircraft, converting one or more crew spoken words to a crew electrical signal with a crew microphone while the public announcement is active, converting the crew electrical signal to a crew source text message based on the crew source language in the server computer, translating the crew source text message to a passenger target text message based on the crew source language and the passenger target language, and displaying the passenger target text message in the passenger target language on a passenger screen at the particular seat.

A method for cabin crew assist on an aircraft is provided herein. The method includes receiving a passenger target language selection for a particular seat among a plurality of seats of the aircraft. The passenger target language selection designates a passenger target language among a plurality of recognizable languages. The method further includes receiving a crew source language selection from an assist display of the aircraft at a server computer. The crew source language selection designates a crew source language among the plurality of recognizable languages. The method includes receiving a notification that a public announcement is active in the aircraft, converting one or more crew spoken words to a crew electrical signal with a crew microphone while the public announcement is active, converting the crew electrical signal to a crew source text message based on the crew source language in the server computer, translating the crew source text message to a passenger target text message based on the crew source language and the passenger target language, and displaying the passenger target text message in the passenger target language on a passenger screen at the particular seat.

In one or more embodiments of the method, the passenger screen is part of an in-flight entertainment system mounted proximate the particular seat.

In one or more embodiments, the method includes transferring the passenger target text message from the server computer to a wireless access point, and transferring the passenger target text message from the wireless access point to a handheld device proximate the particular seat. The passenger screen is part of the handheld device.

In one or more embodiments of the method, the converting of the crew electrical signal to the crew source text message is performed using an artificial intelligence based speech-to-text conversion.

In one or more embodiments of the method, the converting of the crew source text message to the passenger target text message is performed using a natural language based language conversion.

In one or more embodiments, the method includes broadcasting the one or more crew spoken words into a passenger cabin of the aircraft with a public announcement system while the public announcement is active.

An aircraft is provided herein. The aircraft includes a plurality of seats, a crew microphone, an assist display, and a server computer. The server computer is configured to receive a passenger source language selection for a particular seat of the plurality of seats. The passenger source language selection designates a passenger source language among a plurality of recognizable languages. The server computer is further configured to receive a passenger electrical signal representative of one or more passenger spoken words originating from the particular seat of the plurality of seats, convert the passenger electrical signal to a passenger source text message based on the passenger source language, buffer the passenger source text message, activate a service indicator on the assist display in response to the passenger source text message being buffered, wherein the service indicator identifies the particular seat, receive a crew target language selection from the assist display, wherein the crew target language selection designates a crew target language among the plurality of recognizable languages, translate the passenger source text message to a crew target text message in the crew target language based on the passenger source language and the crew target language, and display the crew target text message associated with the particular seat on the assist display.

In one or more embodiments of the aircraft, the server computer is configured to receive a passenger target language selection for the particular seat. The passenger target language selection designates a passenger target language among the plurality of recognizable languages. The server computer is further configured to receive a crew source language selection from the assist display, wherein the crew source language selection designates a crew source language among the plurality of recognizable languages, receive a notification that a public announcement is active, convert one or more crew spoken words to a crew electrical signal with the crew microphone while the public announcement is active, convert the crew electrical signal to a crew source text message based on the crew source language, translate the crew source text message to a passenger target text message based on the crew source language and the passenger target language, and display the passenger target text message in the passenger target language on a passenger screen for the particular seat.

In one or more embodiments, the aircraft includes a wireless access point in communication with the server computer, and configured to transfer the passenger target text message to a handheld device paired to the particular seat.

In one or more embodiments, the aircraft includes an in-flight entertainment system having a passenger microphone mounted proximate the particular seat. The passenger microphone is configured to generate the passenger electrical signal.

In one or more embodiments, the aircraft includes a wireless access point in communication with the server computer, and configured to receive the passenger electrical signal from a handheld device paired to the particular seat.

The above features and advantages, and other features and advantages of the present disclosure are readily apparent from the following detailed description of the best modes for carrying out the disclosure when taken in connection with the accompanying drawings.

### BRIEF DESCRIPTION OF THE DRAWINGS

FIG. 1 is a schematic diagram of an aircraft in accordance with one or more exemplary embodiments.

FIG. 2 is a schematic block diagram of operations within the aircraft in accordance with one or more exemplary embodiments.

FIG. 3 is a schematic block diagram of a server computer in accordance with one or more exemplary embodiments.

FIG. 4 is a flow diagram of a method for processing passenger source messages in accordance with one or more exemplary embodiments.

FIG. 5 is a diagram of a passenger selection screen in accordance with one or more exemplary embodiments.

FIG. 6 is a diagram of a passenger source language selection screen in accordance with one or more exemplary embodiments.

FIG. 7 is a diagram of a start/stop screen in accordance with one or more exemplary embodiments.

FIG. 8 is a diagram of a passenger source text message is shown in accordance with one or more exemplary embodiments.

FIG. 9 is a flow diagram of a method for presenting crew target text messages in accordance with one or more exemplary embodiments.

FIG. 10 is a diagram of a crew language selection screen in accordance with one or more exemplary embodiments.

FIG. 11 is a diagram of a service request screen in accordance with one or more exemplary embodiments.

FIG. 12 is a flow diagram of a method for a cabin crew announcement in accordance with one or more exemplary embodiments.

FIG. 13 is a flow diagram of a method for presenting a passenger target message in accordance with one or more exemplary embodiments.

FIG. 14 is a flow diagram of a method for passenger dual language operations in accordance with one or more exemplary embodiments.

FIG. 15 is a diagram of a passenger target language selection screen in accordance with one or more exemplary embodiments.

FIG. 16 is a flow diagram of a method for speech-to-text conversion in accordance with one or more exemplary embodiments.

### DETAILED DESCRIPTION

Embodiments of the present disclosure include a system and a method for assisting cabin crew members service the passengers on a vehicle (e.g., an aircraft). The system and method utilize artificial intelligence based speech-to-text conversion techniques and natural language processing to establish communication between the passenger and the cabin crew members. Voice requests from the passengers may be presented through backseat microphones (e.g., an in-flight entertainment (IFE) system) and/or through paired handheld devices (e.g., mobile telephones). The voice requests may be made in a native language of the passenger as selected from among a set of recognizable languages. The voice requests from the passengers are converted into text, translated to an appropriate language that the cabin crew members can read, and displayed on a passenger assist display (e.g., a display screen or display panel) in a galley area of the vehicle. A cabin crew member reads the requests on the assist display, selects a particular request, and subsequently addresses the particular request. For example, the cabin crew member may supply water, snacks, other specific material and/or actions to the particular passenger.

Communications are also provided from the cabin crew members to the passengers. For example, a safety briefing spoken by a cabin crew member is automatically converted into text messages and displayed on backseat screens and/or the paired personal mobile telephones of the passengers. The safety briefing is spoken in a language among the recognizable languages selected by the cabin crew members. The text messages displayed to the passengers are translated into corresponding languages among the recognizable languages selected by the individual passengers. The system/method ability to translate among several languages simultaneously eliminates language barriers and so simplifies communication between the passengers and the cabin crew members. Initial messages may be referred to as “source” text messages in a source (speaker) language. Final messages may be referred to as “target” text messages in a target (reader) language. In various embodiments, the vehicle may be an aircraft, a boat, a train, or other vessel that has long, narrow aisles, carries multiple passengers, and carries the cabin crew members that help the passengers.

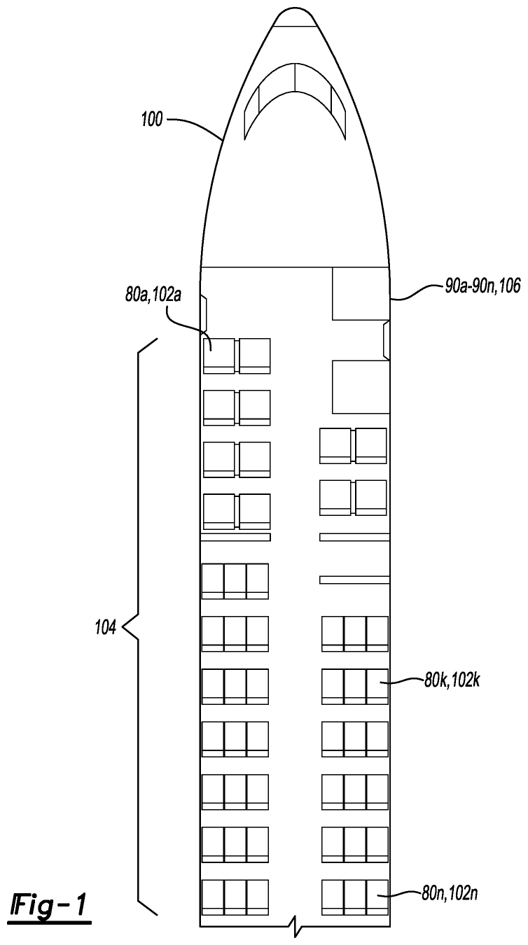

Referring to FIG. 1, a schematic diagram of an example implementation of an aircraft 100 is shown in accordance with one or more exemplary embodiments. The aircraft 100 generally includes multiple seats 102a-102n in a passenger cabin 104, and one or more galley areas 106 (one shown).

The aircraft 100 implements a commercial aircraft. The aircraft 100 is operational to transport multiple passengers 80a-80n and multiple cabin crew members 90a-90n. Each seat 102a-102n may be occupied by a passenger 80a-80n. In various embodiments, each seat 102a-102n may correspond to an in-flight entertainment (IFE) system mounted in a seatback of another seat 102a-102n or a bulkhead in front of the passengers 80a-80n. In some embodiments, each seat 102a-102n may correspond to a wireless communication link that enables handheld devices of the passengers 80a-80n to communicate with the onboard electronics of the aircraft 100. The cabin crew members 90a-90n may be stationed in the galley area 106 and free to move about the passenger cabin 104.

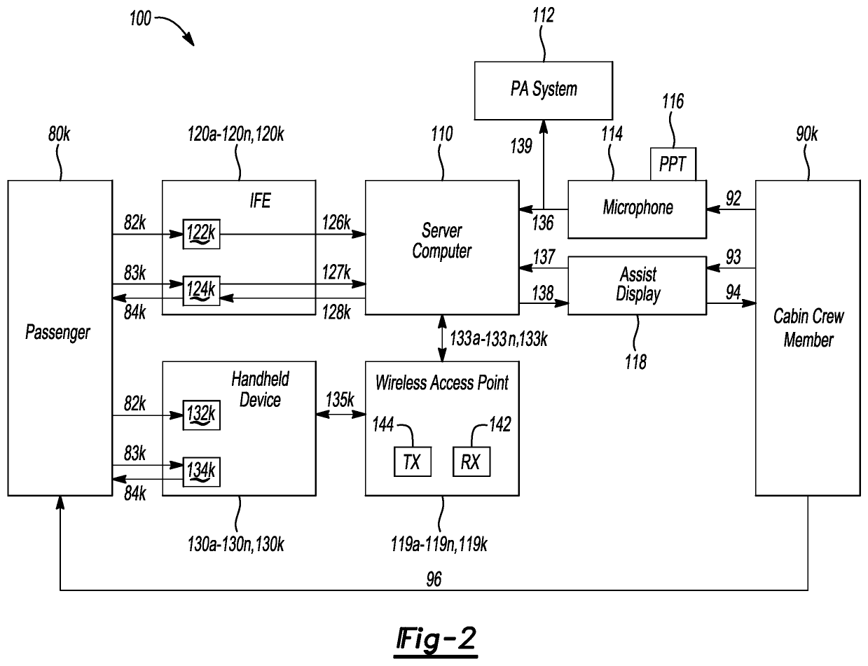

Referring to FIG. 2, a schematic block diagram of example operations within the aircraft 100 are shown in accordance with one or more exemplary embodiments. The example operations illustrate interactions between a particular passenger 80k among the multiple passengers 80a-80n and a particular cabin crew member 90k among the multiple cabin crew members 90a-90n. The particular passenger 80k may occupy a particular seat 102k (see FIG. 1) among the multiple seats 102a-102n.

The aircraft 100 includes a server computer 110, multiple in-flight entertainment systems 120a-120n (e.g., one in-flight entertainment system 120k is shown), a public announcement system 112, a crew microphone 114 having a push-to-talk switch 116, an assist display 118, and multiple wireless access points 119a-119n (one wireless access point 119k is shown). Each wireless access point 119a-119n includes a receiver 142 and a transmitter 144. The crew microphone 114, the push-to-talk switch 116, and the assist display 118 may be located in the galley area 106 of the aircraft 100. In embodiments of the aircraft 100 that include multiple galley areas 106 and/or other areas, a copy of the crew microphone 114, the push-to-talk switch 116, and/or the assist display 118 may be located in each galley area 106 and/or the other areas (e.g., meeting rooms, bar area, and the like). The server computer 110 and the public announcement system 112 may be located within the aircraft 100 based on a configuration of the aircraft 100. The wireless access points 119a-119n may be distributed near to the seats 102a-102n.

In various embodiments, an in-flight entertainment system 120k may be located proximate the particular seat 102k. The in-flight entertainment system 120k generally includes a passenger microphone 122k and a passenger screen 124k with a touchscreen feature. Copies of the in-flight entertainment system 120k may be located proximate each seat 102a-102n.

In some embodiments, the particular passenger 80k may have a handheld device 130k. The handheld device 130k generally includes a handheld passenger microphone 132k and a handheld passenger screen 134k. The handheld device 130k may communicate with the receiver 142 and the transmitter 144 in a particular wireless access point 119k via a wireless link 135k. Copies of the handheld device 130k may be located proximate each seat 102a-102n while the corresponding passengers 80a-80n are seated.

The particular passenger 80k may present one or more passenger spoken words 82k into the passenger microphone 122k and/or the handheld passenger microphone 132k. The passenger microphone 122k may convert the passenger spoken words 82k into a passenger electrical signal 126k received by the server computer 110. The handheld passenger microphone 132k may convert the passenger spoken words 82k into digital data transmitted to the server computer 110 via the wireless link 135k. The particular passenger 80k may enter one or more passenger selections 83k to the touchscreen of the passenger screen 124k. The passenger screen 124k may transfer the passenger selections 83k to the server computer 110 via a passenger selection signal 127k.

The server computer 110 may generate a passenger video signal 128k received by the particular in-flight entertainment system 120k. The passenger video signal 128k conveys a sequence of passenger target images (e.g., graphical user interface images). The passenger target images may be presented by the passenger screen 124k as passenger images 84k seen by the particular passenger 80k. The server computer 110 may also convert the passenger target images into digital data presented to the particular handheld device 130k via the wireless access point 119k and the wireless link 135k. The particular handheld device 130k may present passenger target images on the handheld passenger screen 134k as the passenger images 84k seen by the particular passenger 80k.

The particular cabin crew member 90k may present one or more crew spoken words 92 into the crew microphone 114. The crew microphone 114 may convert the crew spoken words 92 into a crew electrical signal 136 received by the server computer 110 and the public announcement system 112. The particular cabin crew member 90k may enter one or more crew selections 93 to the touchscreen of the assist display 118. The assist display 118 may transfer the crew selections 93 to the server computer 110 via a crew selection signal 137.

The server computer 110 may generate a crew video signal 138 received by the assist display 118. The crew video signal 138 conveys a sequence of crew target images (e.g., graphical user interface images). The crew target images may be presented by the assist display 118 as crew images 94 viewable by the cabin crew members 90a-90n. In the example, the crew images 94 are seen by the particular cabin crew member 90k. Based on the requested services shown in the crew images 94, the particular cabin crew member 90k may provide a requested service 96 to the particular passenger 80k.

The server computer 110 may implement one or more processors, memory, and associated input/output circuitry. In various embodiments, the memory may include non-transitory computer readable memory that stores software. The software is executable by the processors in the server computer 110. The server computer 110 is operational to execute software that provides multiple artificial intelligence based speech-to-text conversions of the passenger electrical signal 126k and the crew electrical signal 136 to create text messages in corresponding source languages. The software may also provide multiple natural language based language conversions that convert source text messages in the source language to target text messages in target languages. The source languages and the target languages may be received by the server computer 110 via the passenger selection signal 127k and the crew selection signal 137.

The public announcement system 112 implements an audio amplifier and multiple speakers. The public announcement system 112 is operational to broadcast a public announcement 139 (e.g., the crew spoken words 92 in the crew electrical signal 136) into the passenger cabin 104 (FIG. 1) in real time (e.g., less than a few millisecond delay) while the push-to-talk switch 116 is in an active position (e.g., the switch is pressed). In some designs, the crew spoken words 92 may be presented from the in-flight entertainment systems 120a-120n and/or the handheld devices 130a-130n. In various embodiments, the public announcement system 112 may also be operational to broadcast spoken words from the flight crew.

The crew microphone 114 implements an audio microphone. The crew microphone 114 is operational to convert the crew spoken words 92 into the crew electrical signal 136 while the push-to-talk switch 116 is in the active position. While the push-to-talk switch 116 is in an inactive position (e.g., the switch is released), the crew microphone 114 suppresses the crew electrical signal 136.

The assist display 118 implements a touchscreen panel disposed in the one or more galley areas 106 and/or a portable wireless device (e.g., a tablet, notebook, smart phone, etc.) moveable around in the aircraft 100. The assist display 118 is operational to generate the crew images 94 in response to the crew video signal 138. The assist display 118 may include menus, icons, and text fields used to present assist requests from the passengers 80a-80n to the cabin crew members 90a-90n. In various embodiments, multiple assist displays (or tablets) 118 may be implemented.

The wireless access points 119a-119n implement communication bridges between the server computer 110 and the handheld devices 130a-130n. Each wireless access point 119a-119n may be operational to communicate with several handheld devices 130a-130n concurrently via the receiver 142 and the transmitter 144. For example, a particular wireless access point 119k may communicate with up to approximately 40 handheld devices 130a-130n at a time via a wireless link 135k. The wireless access points 119a-119n may communicate with the server computer 110 via wireless application protocol (WAP) signals 133a-133n. For example, the wireless access point 119k may communicate with the server computer 110 via a particular wireless application protocol signal 133k.

The in-flight entertainment system 120k implements an audio/visual system that interacts with the particular passenger 80k. The in-flight entertainment system 120k is operational to detect the passenger spoken words 82k originating from the particular seat 102k via the built-in passenger microphone 122k. The in-flight entertainment system 120k is also operational to present the passenger images 84k via the built-in passenger screen 124k.

The handheld device 130k implements a portable device. In various embodiments, the handheld device 130k may include, but is not limited to, a smart telephone, a tablet, a laptop computer, a personal digital assistant, or the like. The handheld device 130k is operational to communicate with the server computer 110 via the particular wireless access point 119k and the wireless link 135k. The handled device 130k is also operational to detect the passenger spoken words 82k originating from the particular seat 102k via the built-in handheld passenger microphone 132k, and present the passenger images 84k via the built-in handheld passenger screen 134k. The handheld device 130k may be paired with a corresponding seat 102k by use of a bar code posted near the seat 102k, entry of a row and seat number of the seat 102k into the handheld device 130k, or similar techniques. Once the handheld device 130k and the seat 102k are paired, the passenger 80k carrying the handheld device 130k may move about the passenger cabin 104 and still maintain the link between the handheld device 130k and the server computer 110.

The wireless link 135k may implement a short-range, bidirectional wireless communication channel that pairs the handheld device 130k with the particular wireless access point 119k. A corresponding wireless link 135k may be provided by each wireless access point 119a-119n. In various embodiments, the wireless link 135k may be a Bluetooth link, a wi-fi link, a near-field communication link, or a wireless Ethernet link. Other types of wireless links 135k may be implemented to meet a design criteria of a particular application.

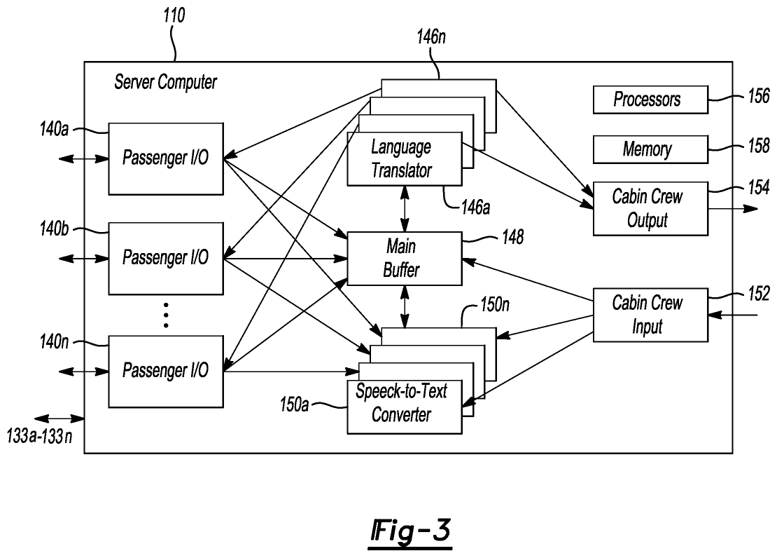

Referring to FIG. 3, a schematic block diagram of an example implementation of the server computer 110 is shown in accordance with one or more exemplary embodiments. The server computer 110 includes multiple passenger input/output (I/O) circuits 140a-140n, multiple language translators 146a-146n, a main buffer circuit 148, multiple speech-to-text converters 150a-150n, a cabin crew input circuit 152, a cabin crew output circuit 154, one or more processors 156 (one shown), and one or more memory circuits 158 (one shown).

The passenger input/output circuits 140a-140n are operational to provide bidirectional communications with the in-flight entertainment systems 120a-120n (FIG. 2). The passenger input/output circuits 140a-140n may digitize a corresponding passenger electrical signal 126k, receive passenger source language selections, and receive passenger target language selections from the in-flight entertainment systems 120a-120n. The passenger input/output circuits 140a-140n transfer the digitized passenger spoken words and the selected passenger source languages to the speech-to-text converters 150a-150n based on the selected passenger source languages. Target passenger text messages may be received by the passenger input/output circuits 140a-140n from the language translators 146a-146n. The passenger input/output circuits 140a-140n may format the passenger target text messages into readable characters in the corresponding passenger video signal 128k. In various embodiments, the passenger input/output circuits 140a-140n may be implemented in whole or in part within the in-flight entertainment system 120a-120n.

The language translators 146a-146n implement software programs stored in the memory circuit 158 and executed by the processors 156. The language translators 146a-146n are operational to read a source text message written in a source language from the main buffer circuit 148 and convert that text message into a target text message written in a target language. The recognizable languages may include English, German, French, Spanish Dutch, Chinese, and the like. Each language translator 146a-146n is configured to translate between two of the recognizable languages. In some embodiments, a number of language translators 146a-146n may be similar to the number of recognizable languages plus several more for reserves. Therefore, the language translators 146a-146n may translate a cabin crew announcement into each recognizable language concurrently and still allow for some passengers 80a-80n to request service (via source text messages) during the announcement.

The main buffer circuit 148 implements a memory buffer. The main buffer circuit 148 is operational to temporarily store source text messages, source languages selection, and target language selections generated by the passengers 80a-80n and the cabin crew members 90a-90n concurrently. The source text messages and source language selections are received into the main buffer circuit 148 from the speech-to-text converters 150a-150n. The target language selections are received from the passenger input/output circuits 140a-140n and the cabin crew input circuit 152. The source text messages, the source language selections, and the target language selections are read out to the language translators 146a-146n for conversion into target text messages in the target languages.

The speech-to-text converters 150a-150n implement software programs stored in the memory circuit 158 and executed by the processors 156. The speech-to-text converters 150a-150n are operational to generate the source text messages by converting the spoken words in the digital signals based on the particular source languages. Generally, each speech-to-text converter 150a-150n is tuned for efficient conversion of the spoken words in a particular source language. In various embodiments, a single speech-to-text converter 150a-150n is implemented for each of the recognized languages. In other embodiments, multiple speech-to-text converters 150a-150n are implemented for one or more of the recognized languages such that one or more conversions in that recognized language may take place concurrently.

The cabin crew input circuit 152 is operational to provide communications with the crew microphone 114 and the assist display 118. The cabin crew input circuit 152 converts the crew electrical signals received from the crew microphone 114 into digital data. The cabin crew input circuit 152 also receives a crew source language selection and a crew target language selection from the touch-screen feature of the assist display 118. In embodiments involving multiple assist displays 118, each assist display 118 may be configured with the same or different crew source languages, and the same or different crew target languages. Therefore, a cabin crew member 90a-90n in the gally area 106 may use an assist display 118 (e.g., a fixed touch screen) in a first crew language while another cabin crew member 90a-90n may concurrently use another assist display (e.g., a tablet) in a second crew language. The digital data and the crew target language selection originating from each assist display 118 are presented to one of the speech-to-text converters 150a-150n based on the selected crew target language.

The cabin crew output circuit 154 is operational to receive crew target text messages from the language translators 146a-146n. The cabin crew output circuit 154 may format the crew target text messages into readable characters in the crew video signal 138.

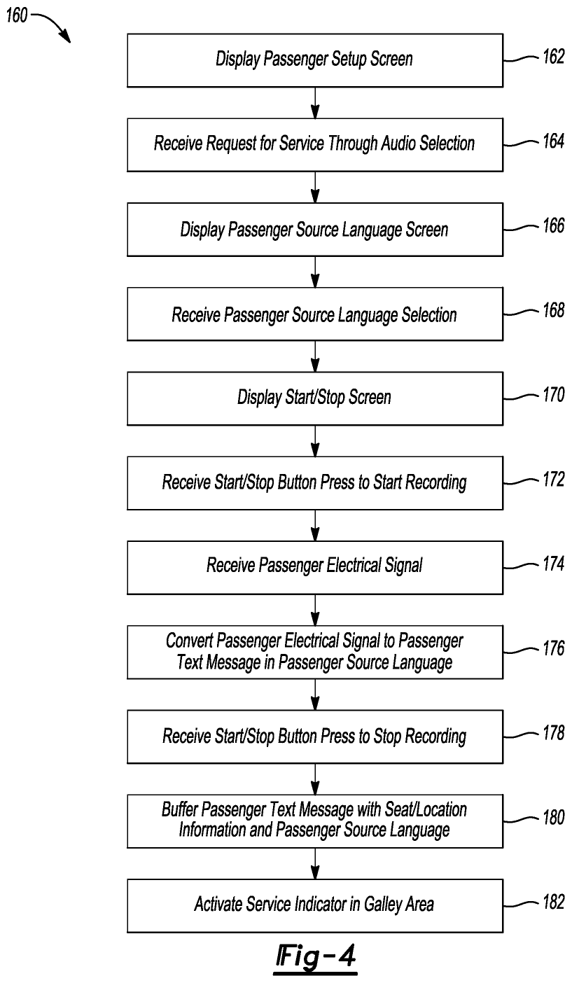

Referring to FIG. 4, a flow diagram of an example implementation of a method 160 for processing passenger source messages is shown in accordance with one or more exemplary embodiments. The method 160 is illustrated for a particular passenger 80k and is applicable to each passenger 80a-80n. The method (or process) 160 may be implemented by the server computer 110, and the particular in-flight entertainment system 120k or the particular handheld device 130k. The method 160 includes steps 162 to 182, as illustrated. The sequence of steps is shown as a representative example. Other step orders may be implemented to meet the criteria of a particular application.

In the step 162, the passenger screen 124k/134k may display a passenger setup screen to the particular passenger 80k. The passenger setup screen provides the particular passenger 80k with options to initiate a service request to the cabin crew members 90a-90n, select a passenger source language that the particular passenger 80k speaks, and select a passenger target language that the particular passenger 80k reads. Depending on the particular passenger 80k, the passenger source language and the passenger target language may be the same or different.

The server computer 110 receives through the in-flight entertainment system 120k or the handheld device 130k a request for service-through-audio selection in the step 164. The server computer 110 responds to the service-through-audio selection in the step 166 by providing video to the passenger screen 124k/134k to display a passenger source recognizable language screen. In the step 168, the server computer 110 receives the passenger source language selection through the touch-panel of the passenger screen 124k/134k. The server computer 110 subsequently presents video to the passenger screen 124k/134k to display a start/stop screen to the particular passenger 80k in the step 170.

In the step 172, the server computer 110 receives a start/stop button press to start recording the passenger spoken words 82k. The server computer 110 receives the passenger electrical signal 126k carrying the passenger spoken words 82k from the passenger microphone 122k/132k in the step 174. A speech-to-text converter 150a-150n corresponding to the passenger source language converts the passenger spoken words 82k to a passenger text message in the passenger source language in the step 176. Once the particular passenger 80k has finished speaking and presses the start/stop button again, the server computer 110 receives the start/stop button press to stop recording in the step 178. The resulting passenger source text message, the seat/location of the particular passenger 80k, and the passenger source language is buffered in the main buffer circuit 148 in the step 180. A service indicator is activated on the assist display 118 in the step 182 in response to the passenger source text message being available in the main buffer circuit 148.

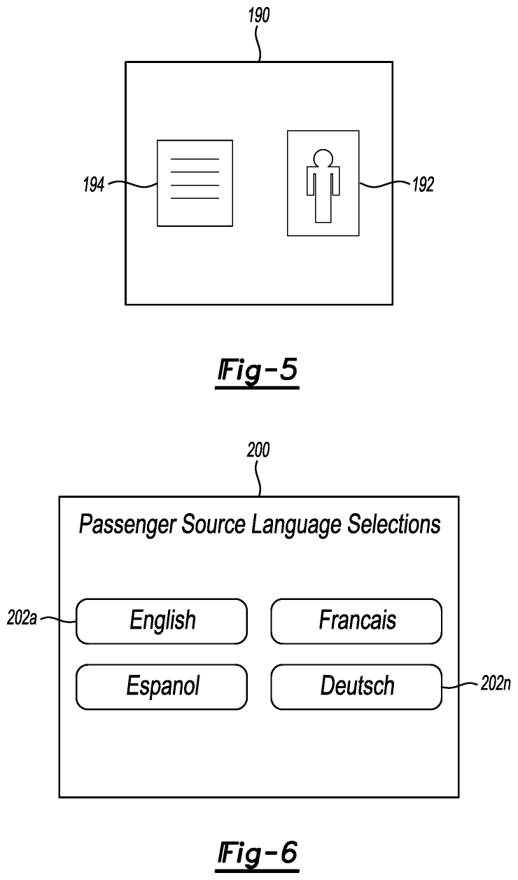

Referring to FIG. 5, a diagram of an example implementation of a passenger selection screen 190 is shown in accordance with one or more exemplary embodiments. The passenger selection screen (or graphical user interface) 190 is illustrated for a single passenger and is applicable to each passenger 80a-80n. A request for service through audio button 192 and a request for text language selection button 194 are provided on the passenger selection screen 190. Upon pressing the request for service through audio button 192, the passenger may see a passenger source language selection screen (FIG. 6). Upon pressing the request for text language selection button 194, the passenger may see a passenger target recognizable selection screen (FIG. 15).

Referring to FIG. 6, a diagram of an example implementation of a passenger source language selection screen 200 is shown in accordance with one or more exemplary embodiments. The passenger source language selection screen (or graphical user interface) 200 is illustrated for a single passenger and is applicable to each passenger 80a-80n. The passenger source language selection screen 200 includes multiple passenger source language buttons 202a-202n. Each passenger source language buttons 202a-202n is labeled with a different language, one language for each language recognized by the speech-to-text converters 150a-150n. Pressing one of the passenger source language buttons 202a-202n will designate to the server computer 110 which particular passenger source language (e.g., 202a) should be used for the words 82a-82n spoken by the corresponding passenger 80a-80n to generate a passenger source text message.

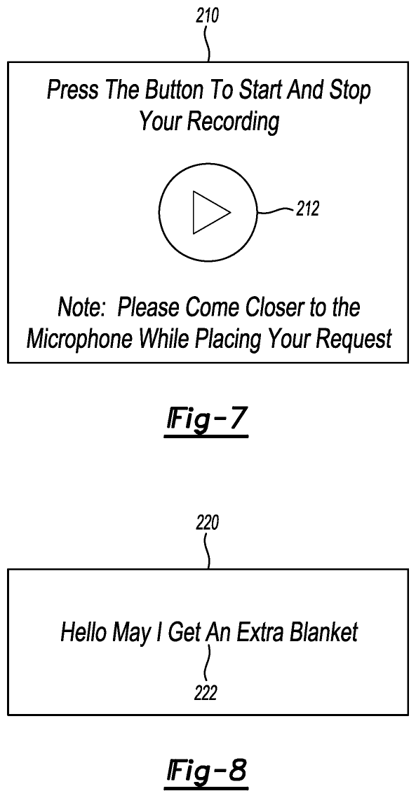

Referring to FIG. 7, a diagram of an example implementation of a start/stop screen 210 is shown in accordance with one or more exemplary embodiments. The start/stop screen 210 is illustrated for a single passenger and is applicable to each passenger 80a-80n. A start/stop button 212 is provided on the start/stop screen 210. An initial press of the start/stop button 212 enables the corresponding passenger to have his/her passenger spoken words 82a-82n recorded and translated into a passenger source text message based on the passenger source language chosen from the passenger source language selection screen 200 (FIG. 6). A subsequent press of the start/stop button 212 ends the recording and translation of the voice of the passenger.

Referring to FIG. 8, a diagram of an example implementation of a passenger source text message 220 is shown in accordance with one or more exemplary embodiments. The passenger source text message 220 includes the passenger spoken words 82a-82n as translated into passenger source text 222. In various embodiments, the passenger source text message 220 may be translated into a crew target text message in a crew target language on the assist display 118. In some embodiments, the passenger source text message 220 may also be displayed back to the particular passenger 80k for confirmation that the server computer 110 properly captured the verbal request for assistance.

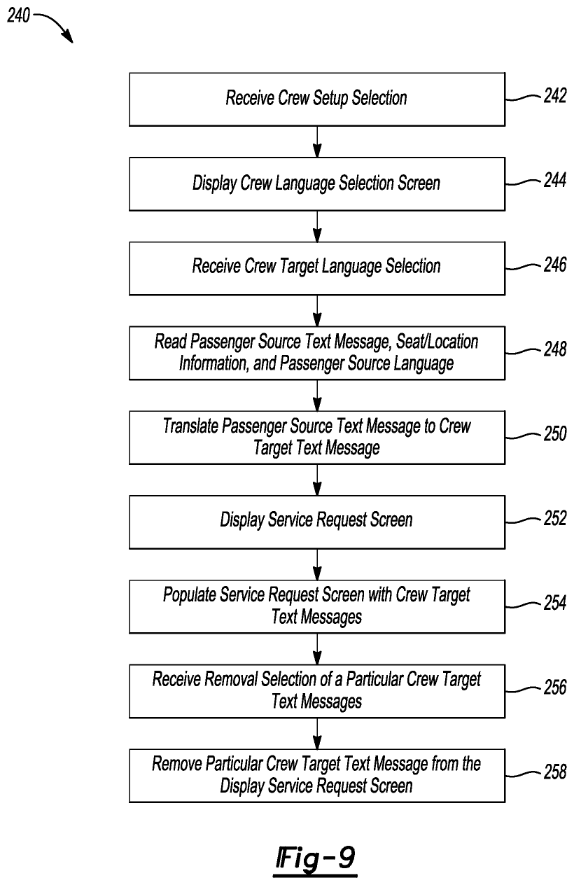

Referring to FIG. 9, a flow diagram of an example implementation of a method 240 for presenting crew target text messages is shown in accordance with one or more exemplary embodiments. The method 240 is illustrated for a particular cabin crew member 90k and is applicable to each cabin crew member 90a-90n. The method (or process) 240 may be implemented by the server computer 110, the crew microphone 114, and the assist display 118. The method 240 includes steps 242 to 258, as illustrated. The sequence of steps is shown as a representative example. Other step orders may be implemented to meet the criteria of a particular application.

In the step 242, the server computer 110 may receive a crew setup selection from the assist display 118 in response to a button press by the particular cabin crew member 90k. The server computer 110 presents a crew video signal 138 to the assist display 118 in the step 244 to display a crew language selection screen to the particular cabin crew member 90k. A crew target language selection is made from the crew language selection screen and received by the server computer 110 in the step 246.

In the step 248, the server computer 110 reads the active (e.g., unanswered) passenger source text messages, seat/location information, and passenger source languages from the main buffer circuit 148. The passenger source text messages are translated in the step 250 to crew target text messages written in the crew target language. A service request screen is displayed on the assist display 118 to the particular cabin crew member 90k in the step 252. The service request screen is populated with crew target text messages in the step 254. A removal selection of a particular crew target text message may be received by the server computer 110 in the step 256. The removal selection generally indicates that the particular cabin crew member 90k is starting to, or has finished, providing the requested service per the particular crew target text message. The server computer 110 responds to the removal request in the step 258 by removing the particular crew target text message from the display service request screen.

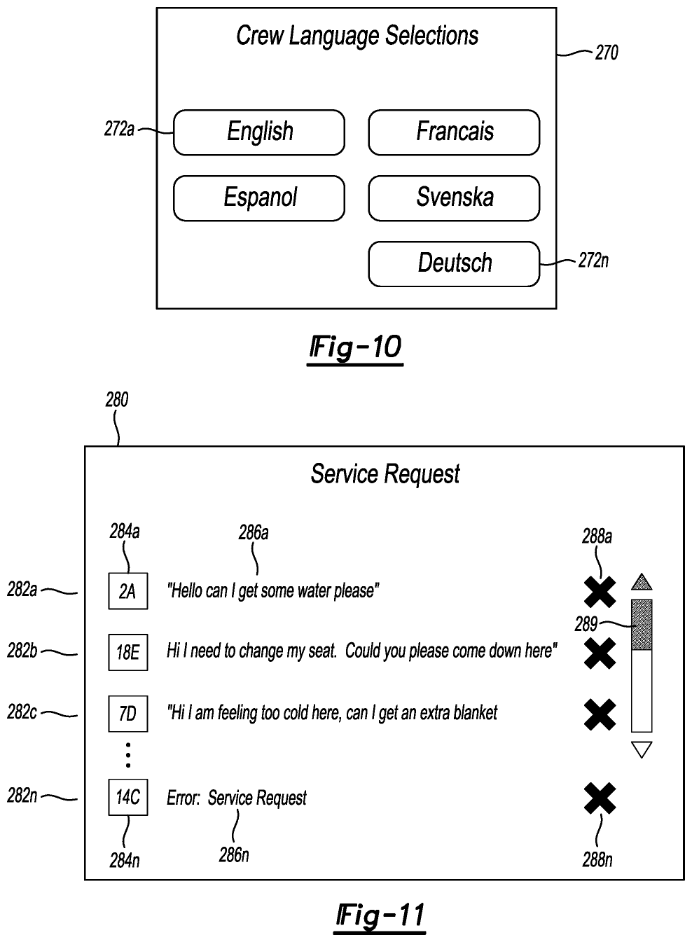

Referring to FIG. 10, a diagram of an example implementation of a crew language selection screen 270 is shown in accordance with one or more exemplary embodiments. The crew language selection screen (or graphical user interface) 270 includes multiple crew target language buttons 272a-272n. Each crew target language buttons 272a-272n is labeled with a different language, one language for each language recognized by the language translators 146a-146n. Pressing one of the crew target language buttons 272a-272n will designate to the server computer 110 which particular crew target language (e.g., 272a) should be used for translating the passenger source text messages in the passenger source languages to the crew target text messages in the crew target language. In various embodiments, the server computer 110 may treat the crew target language to be the same as a crew source language used to convert the crew spoken words 92 into crew source text messages. In other embodiments, the server computer 110 may receive a separate crew source language selection from the assist display 118, where the crew source language is different from the crew target language. Therefore, one cabin crew member 90a-90n may be speaking to the passengers 80a-80n via the public announcement system 112 in one language while another cabin crew member 90a-90n is reading a crew target text message on the assist display 118 in a different language.

Referring to FIG. 11, a diagram of an example implementation of a service request screen 280 is shown in accordance with one or more exemplary embodiments. The service request screen 280 includes multiple service indicators 282a-282n and a scroll bar 289. Each service indicator 282a-282n includes a seat location 284a-284n, a corresponding crew target text message 286a-286n, and a corresponding acknowledge selection 288a-288n. Each crew target text message 286a-286n generally occupies one or a few lines of text.

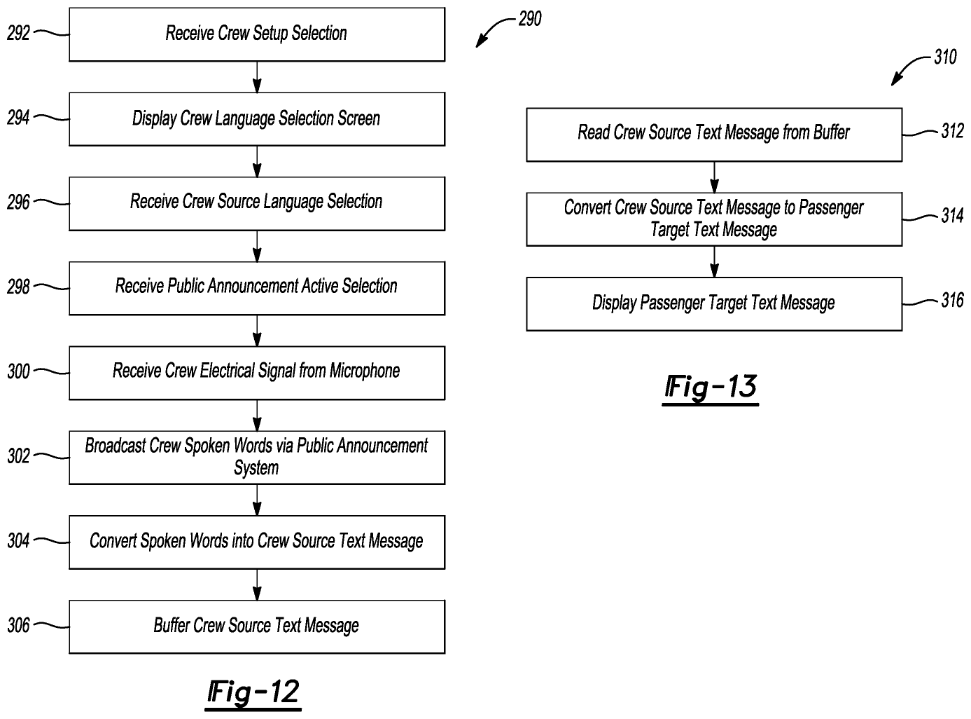

Referring to FIG. 12, a flow diagram of an example implementation of a method 290 for a cabin crew announcement is shown in accordance with one or more exemplary embodiments. The method (or process) 290 may be implemented by the server computer 110, the public announcement system 112, the crew microphone 114, the assist display 118, and the in-flight entertainment system 120a-120n or the handheld devices 130a-130n. The method 290 includes steps 292 to 306, as illustrated. The sequence of steps is shown as a representative example. Other step orders may be implemented to meet the criteria of a particular application.

In the step 292, the server computer 110 may receive a crew setup selection via the assist display 118. In response to the crew setup selection, the server computer 110 may cause the crew language selection screen 270 (FIG. 10) to be shown on the assist display 118 in the step 294. A crew source language selection is subsequently received by the server computer 110 in the step 296.

Upon pressing the push-to-talk switch 116 on the crew microphone 114, the server computer 110 may receive a notification in the step 298 that the public announcement 139 is active. In the step 300, the server computer 110 and the public announcement system 112 each receive the crew spoken words (e.g., crew spoken words 92 from the particular cabin crew member 90k) in the crew electrical signal 136 from the crew microphone 114. The public announcement system 112 broadcasts the crew spoken words 92 in the step 302. During the broadcast, the server computer 110 converts crew spoken words 92 into a crew source text message in the step 304 using an artificial intelligence based speech-to-text conversion tuned from the crew source language selection. The crew source text message is buffered in the main buffer circuit 148 in the step 306 for subsequent translation into the various passenger target languages.

Referring to FIG. 13, a flow diagram of an example implementation of a method 310 for presenting a passenger target message is shown in accordance with one or more exemplary embodiments. The method (or process) 310 may be implemented by the server computer 110, and the in-flight entertainment system 120a-120n or the handheld devices 130a-130n. The method 310 includes steps 312 to 316, as illustrated. The sequence of steps is shown as a representative example. Other step orders may be implemented to meet the criteria of a particular application.

In the step 312, the crew source text message is read from the main buffer circuit 148. Multiple ones of the language translators 146a-146n in the server computer 110 convert the crew source text message in the step 314 into multiple passenger target text messages concurrently using the natural language based language conversions. In the step 316, the passenger target text messages are displayed to the passengers 80a-80n thru the passenger screens 124a-124n or the handheld passenger screens 134a-134n.

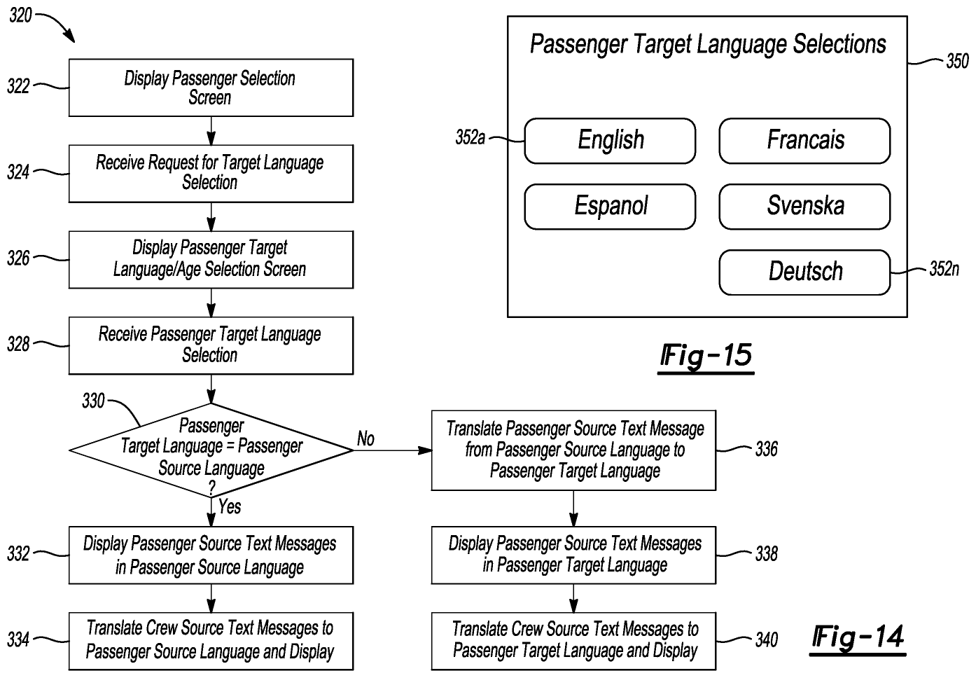

Referring to FIG. 14, a flow diagram of an example implementation of a method 320 for passenger dual language operations is shown in accordance with one or more exemplary embodiments. The method (or process) 320 may be implemented by the server computer 110, and the in-flight entertainment system 120a-120n or the handheld devices 130a-130n. The method 320 includes steps 322 to 340, as illustrated. The sequence of steps is shown as a representative example. Other step orders may be implemented to meet the criteria of a particular application.

In the step 322, the server computer 110 may generate, and the in-flight entertainment system 120a-120n or the handheld devices 130a-130n display the passenger selection screen 190 (FIG. 5). Upon receiving a selection of the request for text language selection button 194 in the step 324, the server computer 110 may generate a passenger target language selection screen (FIG. 15) in the step 326. The server computer 110 receives a passenger target language selection in the step 328.

In the step 330, the server computer 110 checks if the passenger target language matches the passenger source language. If the target language and the source language match, the server computer 110 generates the passenger source text messages in the passenger source language in the step 332. The server computer 110 also translates the crew source text messages to the passenger target text messages in the passenger source languages in the step 334.

If the passenger source language is different than the passenger target language, the server computer 110 translates the passenger source text message from the passenger source language to the passenger target language in the step 336. The passenger source text messages in the passenger target language may be displayed in the step 338. Similarly, the crew source text messages may be translated to the passenger target text messages in the passenger target language and displayed in the step 340.

Referring to FIG. 15, a diagram of an example implementation of a passenger target language selection screen 350 is shown in accordance with one or more exemplary embodiments. The passenger target language selection screen 350 is illustrated for a single passenger and is applicable to each passenger 80a-80n. The passenger target language selection screen 350 includes multiple passenger target language buttons 352a-352n. Each passenger target language button 352a-352n is labeled with a different language, one language for each of the languages recognized by the speech-to-text converters 150a-150n. Pressing a passenger target language button 352a-352n will signal the server computer 110 which particular passenger target language should be used to translate text messages in the main buffer circuit 148 into passenger target text messages in the passenger target language.

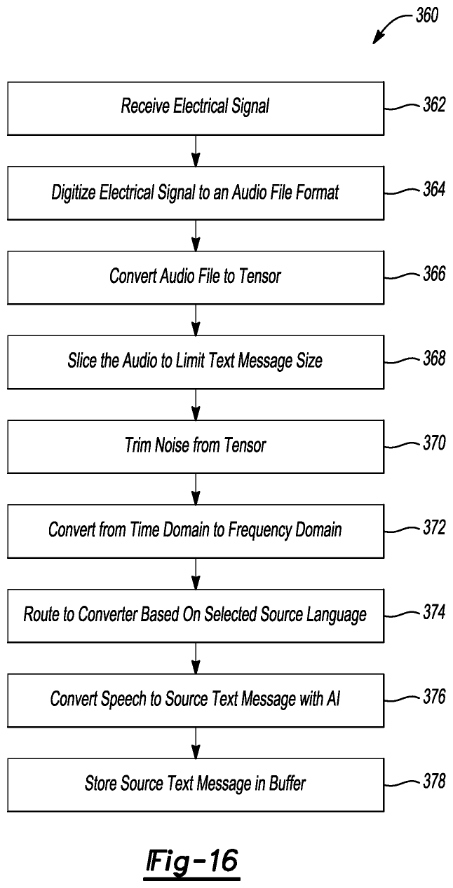

Referring to FIG. 16, a flow diagram of an example implementation of a method 360 for speech-to-text conversion is shown in accordance with one or more exemplary embodiments. The method (or process) 360 may be implemented by the server computer 110. The method 360 includes steps 362 to 378, as illustrated. The sequence of steps is shown as a representative example. Other step orders may be implemented to meet the criteria of a particular application.

In the step 362, the server computer 110 receives an electrical signal. The electrical signal may be a passenger electrical signal 126k or the crew electrical signal 136. The electrical signal is digitized into an audio file format in the step 364. In some embodiments, the file format may be a .wav file format. Other audio file formats may be implemented to meet a design criteria of a particular application.

In the step 366, the audio file may be converted to a tensor file. The server computer 110 may slice the audio in the tensor file in the step 368 to limit a size of the resulting text message to within a practical maximum size. Noise is trimmed from the tensor file in the step 370. The tensor file is converted from a time domain to a frequency domain in the step 372.

In the step 374, the frequency domain data is routed to a speech-to-text converter 150a-150n. The particular speech-to-text converter 150a-150n is chosen based on the corresponding source language. The chosen speech-to-text converter 150a-150n converts the speech to a source text message in the step 376 using an artificial intelligence based speech-to-text conversion. The source text message in the source language is buffered in the main buffer circuit 148 in the step 378.

Embodiments of the system/method generally improve the productivity of the cabin crew members 90a-90n, reduce fatigue on the cabin crew members 90a-90n due to reduced movement across the aisle(s), overcome language barriers between the passengers 80a-80n and the cabin crew members 90a-90n, and improve passenger service quality. By providing communication between the passengers 80a-80n sitting in the respective seats 102a-102n and the cabin crew members 90a-90n in the galley area 106 and/or in other parts of the aircraft 100, there may be less congestion in the aisle(s) of the aircraft 100, a reduction in touch points, and so an increase in safety against germs and viruses.

When a particular passenger 80k requests water, snacks, or other specific requests, he/she may request assistance verbally. The verbal request is converted into a passenger source text message, translated into a crew target text message, and displayed on the assist display 118. A cabin crew member 90a-90n reads the request and walks to the particular passenger 80k with water, snack or other specific request. When an announcement is made over the public announcement system 112, the words may be converted to text and translated in real time to various languages preferred by the various passengers 80a-80n. The text versions of the public announcements also accommodate hearing-challenged passengers 80a-80n by providing the public announcements in readable form.

The same infrastructure may be used to convert cabin crew announcements (ex. safety briefing) into text messages displayed on the backseat screens of the in-flight entertainment systems 120a-120n. For airliners replacing the in-flight entertainment systems 120a-120n with pairings to mobile phones(e.g., handheld devices 130a-130n), the passengers 80a-80n, the text messages may be transmitted to the mobile phones for display to the passengers 80a-80n.

This disclosure is susceptible of embodiments in many different forms. Representative embodiments of the disclosure are shown in the drawings and will herein be described in detail with the understanding that these embodiments are provided as an exemplification of the disclosed principles, not limitations of the broad aspects of the disclosure. To that extent, elements and limitations that are described, for example, in the Abstract, Background, Summary, and Detailed Description sections, but not explicitly set forth in the claims, should not be incorporated into the claims, singly or collectively, by implication, inference or otherwise.

For purposes of the present detailed description, unless specifically disclaimed, the singular includes the plural and vice versa. The words “and” and “or” shall be both conjunctive and disjunctive. The words “any” and “all” shall both mean “any and all”, and the words “including,” “containing,” “comprising,” “having,” and the like shall each mean “including without limitation.” Moreover, words of approximation such as “about,” “almost,” “substantially,” “approximately,” and “generally,” may be used herein in the sense of “at, near, or nearly at,” or “within 0-5% of,” or “within acceptable manufacturing tolerances,” or other logical combinations thereof. Referring to the drawings, wherein like reference numbers refer to like components.

The detailed description and the drawings or FIGS. are supportive and descriptive of the disclosure, but the scope of the disclosure is defined solely by the claims. While some of the best modes and other embodiments for carrying out the claimed disclosure have been described in detail, various alternative designs and embodiments exist for practicing the disclosure defined in the appended claims. Furthermore, the embodiments shown in the drawings or the characteristics of various embodiments mentioned in the present description are not necessarily to be understood as embodiments independent of each other. Rather, it is possible that each of the characteristics described in one of the examples of an embodiment may be combined with one or a plurality of other desired characteristics from other embodiments, resulting in other embodiments not described in words or by reference to the drawings. Accordingly, such other embodiments fall within the framework of the scope of the appended claims.

What is claimed is:

1. A method for cabin crew assist on an aircraft comprising:
receiving a passenger source language selection for a particular seat of a plurality of seats of the aircraft at a server computer, wherein the passenger source language selection designates a passenger source language among a plurality of recognizable languages;
receiving a passenger electrical signal representative of one or more passenger spoken words originating from the particular seat;
converting the passenger electrical signal to a passenger source text message based on the passenger source language;
buffering the passenger source text message;
activating a service indicator on an assist display of the aircraft in response to the passenger source text message being buffered, wherein the service indicator identifies the particular seat;
receiving a crew target language selection from the assist display, wherein the crew target language selection designates a crew target language among the plurality of recognizable languages;
translating the passenger source text message to a crew target text message in the crew target language based on the passenger source language and the crew target language; and
displaying the crew target text message associated with the particular seat on the assist display.

2. The method according to claim 1, further comprising:
generating the passenger electrical signal with a passenger microphone in an in-flight entertainment system, wherein the in-flight entertainment system is mounted proximate the particular seat.

3. The method according to claim 1, further comprising:
generating the passenger electrical signal in a handheld device, wherein the handheld device is paired to the particular seat;
transferring the passenger electrical signal from the handheld device to a wireless access point located in the aircraft; and
transferring the passenger electrical signal from the wireless access point to the server computer.

4. The method according to claim 1, further comprising:
receiving an acknowledge selection from the assist display after the crew target text message is displayed on the assist display.

5. The method according to claim 4, further comprising:
removing the crew target text message from the assist display in response to the acknowledge selection.

6. The method according to claim 1, further comprising:
displaying the passenger source text message in the passenger source language on a passenger screen for the particular seat.

7. The method according to claim 1, further comprising:
receiving a passenger target language selection for the particular seat, wherein the passenger target language selection designates a passenger target language among the plurality of recognizable languages, and the passenger target language is different than the passenger source language.

8. The method according to claim 7, further comprising:
translating the passenger source text message from the passenger source language to the passenger target language; and
displaying the passenger source text message in the passenger target language at the particular seat.

9. The method according to claim 1, further comprising:
receiving a passenger target language selection for the particular seat among the plurality of seats of the aircraft, wherein the passenger target language selection designates a passenger target language among the plurality of recognizable languages;
receiving a crew source language selection selected from the assist display of the aircraft at the server computer, wherein the crew source language selection designates a crew source language among the plurality of recognizable languages;
receiving a notification that a public announcement is active in the aircraft;
converting one or more crew spoken words to a crew electrical signal with a crew microphone while the public announcement is active;
converting the crew electrical signal to a crew source text message based on the crew source language in the server computer;
translating the crew source text message to a passenger target text message based on the crew source language and the passenger target language; and
displaying the passenger target text message in the passenger target language on a passenger screen at the particular seat.

10. A method for cabin crew assist on an aircraft comprising:
receiving a passenger target language selection for a particular seat among a plurality of seats of the aircraft, wherein the passenger target language selection designates a passenger target language among a plurality of recognizable languages;
receiving a crew source language selection from an assist display of the aircraft at a server computer, wherein the crew source language selection designates a crew source language among the plurality of recognizable languages;
receiving a notification that a public announcement is active in the aircraft;
converting one or more crew spoken words to a crew electrical signal with a crew microphone while the public announcement is active;
converting the crew electrical signal to a crew source text message based on the crew source language in the server computer;
translating the crew source text message to a passenger target text message based on the crew source language and the passenger target language; and
displaying the passenger target text message in the passenger target language on a passenger screen at the particular seat.

11. The method according to claim 10, wherein the passenger screen is part of an in-flight entertainment system mounted proximate the particular seat.

12. The method according to claim 10, comprising:
transferring the passenger target text message from the server computer to a wireless access point; and
transferring the passenger target text message from the wireless access point to a handheld device proximate the particular seat, wherein the passenger screen is part of the handheld device.

13. The method according to claim 10, wherein the converting of the crew electrical signal to the crew source text message is performed using an artificial intelligence based speech-to-text conversion.

14. The method according to claim 10, wherein the converting of the crew source text message to the passenger target text message is performed using a natural language based language conversion.

15. The method according to claim 10, further comprising:
broadcasting the one or more crew spoken words into a passenger cabin of the aircraft with a public announcement system while the public announcement is active.

16. An aircraft comprising:
a plurality of seats;
a crew microphone;
an assist display; and
a server computer configured to:
receive a passenger source language selection for a particular seat of the plurality of seats, wherein the passenger source language selection designates a passenger source language among a plurality of recognizable languages;
receive a passenger electrical signal representative of one or more passenger spoken words originating from the particular seat of the plurality of seats;
convert the passenger electrical signal to a passenger source text message based on the passenger source language;
buffer the passenger source text message;
activate a service indicator on the assist display in response to the passenger source text message being buffered, wherein the service indicator identifies the particular seat;
receive a crew target language selection from the assist display, wherein the crew target language selection designates a crew target language among the plurality of recognizable languages;
translate the passenger source text message to a crew target text message in the crew target language based on the passenger source language and the crew target language; and
display the crew target text message associated with the particular seat on the assist display.

17. The aircraft according to claim 16, wherein the server computer is further configured to:
receive a passenger target language selection for the particular seat, wherein the passenger target language selection designates a passenger target language among the plurality of recognizable languages;
receive a crew source language selection from the assist display, wherein the crew source language selection designates a crew source language among the plurality of recognizable languages;
receive a notification that a public announcement is active;
convert one or more crew spoken words to a crew electrical signal with the crew microphone while the public announcement is active;
convert the crew electrical signal to a crew source text message based on the crew source language;
translate the crew source text message to a passenger target text message based on the crew source language and the passenger target language; and
display the passenger target text message in the passenger target language on a passenger screen for the particular seat.

18. The aircraft according to claim 17, further comprising a wireless access point in communication with the server computer, and configured to transfer the passenger target text message to a handheld device paired to the particular seat.

19. The aircraft according to claim 16, further comprising an in-flight entertainment system having a passenger microphone mounted proximate the particular seat, wherein the passenger microphone is configured to generate the passenger electrical signal.

20. The aircraft according to claim 16, further comprising a wireless access point in communication with the server computer, and configured to receive the passenger electrical signal from a handheld device paired to the particular seat.
